(19) United States
(12) Patent Application Publication
(10) Pub. No.: US 2026/0350238 A1
(43) Pub. Date: Nov. 5, 2026

(54) SECURITY ARCHITECTURE FOR ON-THE-FLY DECRYPTION WITHIN A MEMORY SYSTEM

(71) Applicant: Micron Technology, Inc., Boise, ID (US)

(72) Inventor: Lance W. Dover, Fair Oaks, CA (US)

(21) Appl. No.: 19/195,510

(22) Filed: Apr. 30, 2025

(51) Int. Cl. G06F 21/79; G06F 21/60; G06F 21/64

(52) U.S. Cl. CPC G06F 21/79; G06F 21/602; G06F 21/64

(57) ABSTRACT

Methods, systems, and devices for on-the-fly decryption within a memory system are described. For example, the memory system and a host system may share a root key that may be used for derivation of subsequent symmetric session keys. The host system may encrypt data using the session keys and may transmit the encrypted data to the memory system with verification information to be stored with the data. The memory system may receive and store the verification information and data in an encrypted form. During an access operation, the memory system may access at least a portion of the encrypted data in a memory array and may decrypt the data in accordance with the session keys on-the-fly. After decrypting and verifying the data using the session keys and the verification information, the memory system may use the data to perform one or more operations associated with the access operation.

### TECHNICAL FIELD

The following relates to one or more systems for memory, including security architecture for on-the-fly decryption within a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports security architecture for on-the-fly decryption within a memory system in accordance with examples as disclosed herein.

FIG. 2 shows an example of a security architecture that supports security architecture for on-the-fly decryption within a memory system in accordance with examples as disclosed herein.

FIG. 3 shows an example of a process flow that supports security architecture for on-the-fly decryption within a memory system in accordance with examples as disclosed herein.

FIG. 4 shows a block diagram of a memory system that supports security architecture for on-the-fly decryption within a memory system in accordance with examples as disclosed herein.

FIGS. 5 and 6 show flowcharts illustrating a method or methods that support security architecture for on-the-fly decryption within a memory system in accordance with examples as disclosed herein.

### DETAILED DESCRIPTION

Some memory systems may include architectures to support processor-in-memory (PIM) operations. For example, a memory system may include one or more processor cores within a memory array, such that the memory system may perform various calculations and other processing operations on data within the memory array or on the chip without transferring the data to an external processor. A host system may generate a model for PIM operations by the memory system, where the model may be a large language model (LLM) or some other set of data (e.g., matrices) for performing various computations. The host system may provide the model to the memory at initialization of the system, such that the model may be stored within the memory array and used for processing during system operation. However, if the host system provides the model to the memory system via a bus or another interface without encryption, malicious actors may snoop the bus and detect the model during transmission. Some techniques may provide for the host system to encrypt the model prior to transmission via the interface. For example, the host system may encrypt the model using one or more security keys (e.g., tags, values, other security information) and may transmit the encrypted model and the various security information to the memory system. The memory system may receive the encrypted model and one or more security keys, and may serially decrypt the model before storing the decrypted model (e.g., data of the decrypted model) to the memory system. However, such techniques may increase latency and create a backlog across the bus (e.g., affect link timing), among other examples. Accordingly, PIM models, as well as other memory applications and type of data, may benefit from relatively low overhead security techniques, which may support security of information with reduced backlog and overhead.

As described herein, a host system may encrypt data prior to transmitting the data to the memory system, and the memory system may store the data in an encrypted form (e.g., instead of decrypting as the data is received), which may reduce backlog and increase throughput. The memory system may decrypt the data at the time the data is retrieved from the memory array for performance of one or more associated operations (e.g., on-the-fly, as needed). The memory system and the host system may exchange a root key, for example, in a secure environment before deployment of the memory system (e.g., symmetric-only keys). The host system and the memory system may subsequently use the root key as a seed to key derivation functions (KDFs) used to generate one or more subsequent session keys for encryption and decryption of exchanged data. The relatively infrequency use and exchange of the root key may reduce a likelihood for extraction or snooping of the key. According to the techniques described herein, the host system may generate or otherwise identify data, such as a PIM model, or other data, for storage by a memory system. The host system may encrypt the data using one of the session keys generated from the root key. The host system may transmit the encrypted data to the memory system, which may store the data in an encrypted form. That is, the memory system may not decrypt the data upon receipt, but may write the encrypted data to the memory array. The memory system may decrypt the data as the data (e.g., in decrypted, cleartext form) is accessed for associated operations (e.g., on-the-fly, as needed), which may reduce overhead and may improve bandwidth for transmission of the data to the memory system with reduced latency.

The host system may transmit, with the encrypted data, the one or more tags to the memory system for storage and subsequent verification of the data. In the case that the memory system is accessed or activated for an operation that uses the data, the memory system may use the root key and one or more nonce values as seeds to a KDF for generation of a session key. The memory system may retrieve the relevant data, decrypt the data using the derived session key, and one or more nonce values and tags, and may authenticate the data (e.g., determine whether an authenticated host system signed the data) by comparing a calculated tag to the tags previously-stored with the data. The memory system may thereby decrypt the data using the security architecture in an on-the-fly method, which may decrease write latency at the memory system and may increase security of the data. In some examples, prior to transmitting data to the memory system, the host system may encrypt all of the data using a single key, and the host system may generate and send, with the data, a single corresponding tag to be stored at the memory system. The memory system may use the single tag to verify that the data is from a valid host when decrypting the data. In other examples, the host system may encrypt portions of the data (e.g., rows of memory cells may be encrypted separately) based on an identifier of each portion (e.g., a row address) and a derived key. The host system may generate and transmit a tag for verification of each portion, and the memory system to store the one or more tags with each portion of data.

The described on-the-fly decryption techniques may thereby provide for the host system to write relatively large amounts of data to the memory system at a given time in a secure manner and with reduced latency and improved throughput. The described techniques may improve security within the memory system by, for example, supporting symmetric-only key distribution and erasure of an entire model upon erasure of the symmetric key (e.g., crypto-erase). Such techniques may align well with operations such as PIM operations, among other examples, as logic for securely decrypting and verifying the data may be associated with or otherwise integrated with PIM logic within the memory array. Additionally, or alternatively, PIM may be associated with transfers of relatively large amounts of data at once, which may benefit from the improved throughput and reduced write latency provided by these techniques.

In addition to applicability in memory systems as described herein, techniques for on-the-fly data decryption may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by ensuring that data is securely and reliably exchanged between a memory system and a host system without requiring one-time bulk decryption of the data at the memory system, which may decrease processing or latency times, among other benefits.

In addition to applicability in memory systems described herein, techniques for on-the-fly data decryption may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by enabling a one-time encryption of data prior to transmission to the memory system, such that the memory system may decrypt the data as needed instead of decrypting all of the data at one time when it is received. Such on-the-fly decryption may provide for the memory system and the host system to ensure secure exchanges of data without increasing overhead and latency, among other examples. The described techniques may additionally, or alternatively, provide for varying granularities of data verification, which may improve security and reduce likelihood of malicious attacks, among other benefits.

Features of the disclosure are illustrated and described in the context of systems and security architectures. Features of the disclosure are further illustrated and described in the context of process flows and flowcharts.

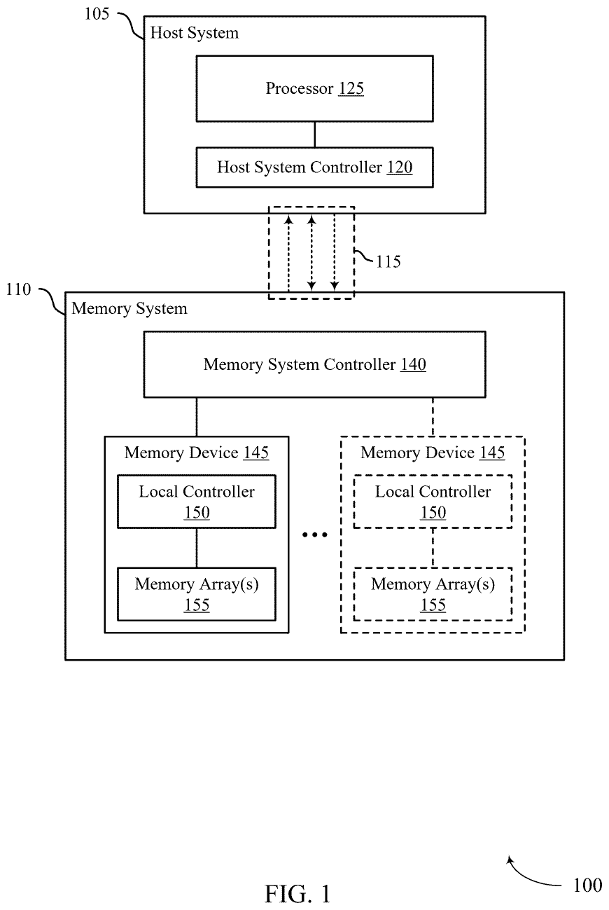

FIG. 1 shows an example of a system 100 that supports security architecture for on-the-fly decryption within a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a neural processing unit (NPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

The system 100 may support memory-level processing operations in which processing capabilities are integrated with the memory device 145. For example, the memory devices 145 may support PIM capabilities. The memory arrays 155 may include memory cells coupled with or otherwise integrated with one or more processing cores or other logic or circuitry configured to perform various processing operations. The processing circuitry may be included in or otherwise coupled with the memory cells themselves (e.g., in each cell, each row, each column, or the like), or may be coupled with or otherwise included in sensing circuitry configured to perform sense operations within the memory arrays 155. Additionally, or alternatively, the processing circuitry may be included at an edge of each memory array 155. Regardless, the processing circuitry may be configured to\perform computations and other processing operations on data directly within the memory arrays 155, rather than transferring the data to the memory system controller 140 or another processor external to the memory arrays 155 (e.g., a CPU). The described PIM techniques may provide for enhanced processing capabilities with reduced latency and reduced overhead, among other examples. PIM operations may support applications such as video streaming or artificial intelligence models, among other examples, due to the relatively high processing capabilities and performance benefits of PIM.

To configure the memory devices 145 for PIM operations, an external system (e.g., the memory system controller 140, the host system 105, the host system controller 120) may store one or more PIM models to memory cells of the memory arrays 155 at initialization of the memory system 110. In some examples, a PIM model may represent data, instructions, equations, or other information that may support various calculations and other processing operations at the designated granularity. A PIM model may, for example, represent an LLM model for execution by the memory devices 145. The memory devices 145 (e.g., the local controllers 150) may thereby perform operations at a memory cell level, a sense amplifier level, at a level of the memory arrays 155, or another granularity, using the stored data in accordance with the instructions (e.g., framework) provided by the PIM model and using the PIM architecture.

In some examples, the initial transfer of the PIM model information from the host system 105 to the memory system 110 may be subject to security risks. For example, if the host system 105 transmits the PIM model to the memory system 110 via a bus or another interface (e.g., the channels 115) without encryption, malicious actors may snoop the channels 115 and detect the PIM model during transmission. Some techniques may provide for the host system 105 to encrypt the PIM model prior to transmission via the channels 115. For example, the host system 105 may encrypt the PIM model using one or more security keys (e.g., tags, values, other security information) and may transmit the encrypted PIM model and the various security information to the memory system 110. The memory system 110 may be configured to receive the encrypted PIM model and one or more security keys, and may serially decrypt the PIM model before storing the decrypted PIM model (e.g., data of the decrypted model) to the memory devices 145. However, such techniques may increase latency of the memory system 110 and create a backlog across the channels 115 (e.g., affect link timing), among other examples. For example, due to the relatively large size of a PIM model, the time for the memory system 110 to process and decrypt the received PIM model before writing the decrypted model data to the memory arrays 155 may be relatively long, which may backup the channels 115, thereby delaying the PIM model write and other subsequent accesses and operations between the host system 105 and the memory system 110.

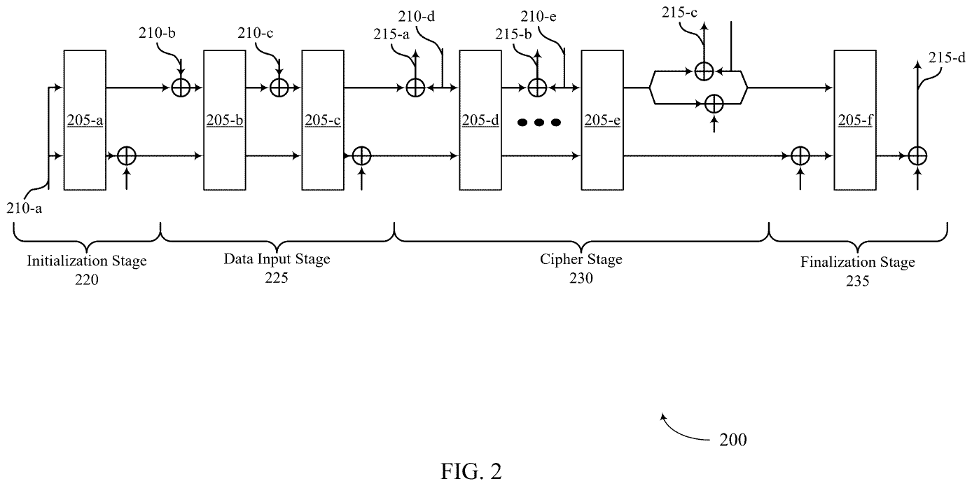

As described herein, the host system 105 may encrypt data prior to transmitting the data to the memory system 110, such that the memory system 110 may store the encrypted data and decrypt the data at the time of associated operations (e.g., on-the-fly, as needed). For example, one or more of the memory devices 145 may be equipped with a security architecture (e.g., as further described herein with reference to FIG. 2) which may support PIM operations and on-the-fly decryption at a memory level. In some examples, the security architecture may provide for symmetric-only key distribution that may support erasure of an entire PIM model upon erasure of the symmetric key (e.g., crypto-erase). The memory system 110 and the host system 105 may exchange a root key during manufacture or in a secure environment before transmission of the PIM model. In some examples, prior to transmitting the PIM model data to the memory system 110, the host system 105 may encrypt all of the data using a single key associated with a single corresponding tag to be stored at the memory devices 145. In other examples, the host system 105 may encrypt sets of the data (e.g., per row of memory cells of the memory arrays 155) based on an identifier of each portion of data (e.g., a row address) and a derived key, which may allow the memory devices 145 to store one or more tags with each portion of data.

The host system 105 may transmit the encrypted data to the memory system 110, and one or more of the memory devices 145 may store the data in an encrypted form. In some examples, the host system 105 may also transmit the one or more tags to the memory system 110 for storage at the memory devices 145. In the case that a memory device 145 is accessed or activated for an operation using the data, the associated memory device 145 may use the root key and one or more nonce values as seeds to generate a session key using a KDF. The memory device 145 may retrieve the relevant data, decrypt the data using the derived session key, and one or more nonce values and tags, and may authenticate the data (e.g., determine whether an authenticated host system signed the data) by comparing a calculated tag to the tags previously-stored with the data. The associated memory device 145 may thereby decrypt the data using the security architecture in an on-the-fly method, which may decrease write latency at the memory system 110 and increase security of the data.

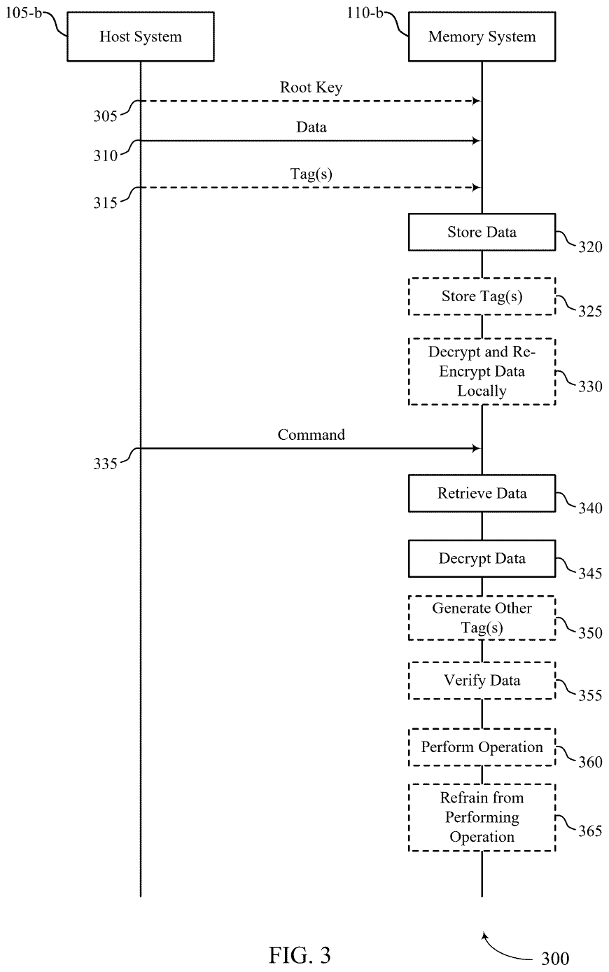

FIG. 2 illustrates an example of a security architecture 200 (e.g., a memory architecture) that supports security architecture for on-the-fly decryption within a memory system in accordance with examples as disclosed herein. The security architecture 200 may be implemented by a memory device 145 or one or more components thereof, such as a local controller 150, or within one or more components thereof, such as a memory array 155, as described with reference to FIG. 1. Aspects of the security architecture 200 may be referred to as or implemented as part of a PIM operation of a memory device, as further described herein with reference to FIGS. 1 and 3, such as a decryption and a re-encryption of PIM model data.

Some systems, such as a host system 105 or a memory device 145 (e.g., as further described herein with reference to FIG. 1) may support PIM operations. For example, a memory system may be equipped with a PIM model that may allow for performance of various operations at a memory-level of the memory system. A host system may generate a model for PIM operations by the memory system, and may load the model data to the memory at initialization of the system. However, if the host system sends the model data to the memory system via a bus or another interface without encryption, malicious actors may snoop the bus and detect the model data during transmission. Some techniques may provide for the host system to encrypt the model prior to transmission via the interface. For example, the host system may encrypt the model data and transmit the encrypted data and various security information (e.g., keys, tags, values) to the memory system, which may receive the encrypted data and one or more security keys and serially decrypt the data before storing the decrypted data. However, such techniques may increase latency and create a backlog across the bus (e.g., affect link timing), among other examples.

To improve security while reducing latency, the techniques described herein provide for the memory system to leverage the security architecture 200 to perform on-the-fly decryption of data stored at the memory system instead of decrypting all of the data before storage. The described techniques may reduce latency and improve throughput and performance for PIM operations or other applications associated with writes of relatively large amounts of data at a time. As further described herein with reference to FIGS. 1 and 3, a host system may encrypt data prior to transmitting the data to the memory system, such that the memory system may store the data in encrypted form and decrypt the data at the time of associated operations (e.g., on-the-fly, as needed). For example, the memory system and the host system may exchange a root key during manufacture or in a secure environment before transmission of the PIM model data. The memory system, the host system, or both may store the root key in one or more fuses or other non-volatile memory for subsequent use as an input to KDFs for generation of session keys each time the memory system, the host system, or both are powered on or otherwise reset. For example, the memory system may include DRAM with field fuse programming to accommodate the root key as well as a mode register command sequence and confirmation to ensure proper programming and commit of the root key. In some examples, the memory system may include one or more backup fuse(s) to enable rework or field re-keying.

In some examples, prior to transmitting the data to the memory system, a host system may encrypt all of the data using a single key associated with a single corresponding tag to be stored at the memory system. In other examples, the host system may encrypt portions of the data (e.g., per row of memory cells) based on an identifier of each set (e.g., a row address) and a derived key, which may allow the memory system to store one or more tags with each portion of data. The host system may transmit the encrypted data to the memory system, and the memory system may store the data in an encrypted form. In some examples, the host system may also transmit the one or more tags to the memory system for storage. Techniques for generation of the tags, as well as the session keys, are described in further detail elsewhere herein, including with reference to FIG. 3.

One or more memory devices of the memory system may include the security architecture 200 to facilitate on-the-fly decryption of the data. The security architecture 200 may represent examples of components or logic that may be integrated, in some examples, with processing components or logic that support PIM operations at a memory level. That is, the described techniques may integrate the on-the-fly decryption with PIM processing operations. In the case that the memory system receives a command associated with the encrypted, stored data, the memory system may retrieve the requested data and associated tags from memory, and may decrypt the data using the security architecture 200 and one or more keys that may be derived in accordance with the root key. For example, the security architecture 200 may include one or more phases 205. Each phase 205 may be an example of a permutation of one or more variables (e.g., received at the phase 205 via inputs 210) and the encrypted data. Each phase 205 may include or otherwise be performed by one or more computation components within the memory array or logic within the memory array. For example, the security architecture 200 may be integrated into the memory array and processing components therein. The security architecture 200 may output, after the phases 205-a through 205-f, a decrypted version of the data and a tag associated with the data. The security architecture 200 may, in some examples, also output a re-encrypted version of the data (e.g., a re-encrypted counterpart) for storage back in the memory array.

During an initialization stage 220, the associated memory device may generate a nonce for decoding the chunk of data. The nonce may be generated for each set of data for encryption that is associated with a tag. For example, if the host system encrypts the data on a row-by-row basis, the memory device may decode one row at a time, and may generate a respective nonce for each row. The nonce may be generated in accordance with or otherwise based on a current session key (e.g., derived from the root key). If the nonce is generated per row, or per other subset of data, the nonce may be further based on an identifier of the set of data, such as a row address. The nonce value and the session key may be input into the phase 205-a via the input 210-a. The security architecture may execute one or more permutations on the inputs 210-a during the phase 205-a.

During a data input stage 225, the memory device may input the encrypted data (e.g., the PIM model data, which may include one or more matrices) into the phase 205-b via the input 210-b and the phase 205-c via the input 210-c. In some examples, the memory device may pad the encrypted data prior to inputting it into the security architecture 200. The encrypted data may include the chunk of model data, such as one or more matrices or matrix entries that may be used for PIM operations, among other examples. The phase 205-b and the phase 205-c may perform one or more permutation operations on the data using the derived session key, the one or more tags, and the one or more nonce values before passing the processed data to the phase 205-d in the cipher stage 230. During the cipher stage 230, the data may be decrypted. For example, the cipher stage 230 may iterate over the data for one or more phases 205, such as the phases 205-d and 205-e in FIG. 2, or some other quantity of phases. At each phase 205, a respective input 210 (e.g., inputs 210-d and 210-e) may be provided for facilitating the next permutation of the data. A quantity of phases 205 for decryption of the data may be based on a size of the data. For example, a two kilobyte row of data may go through 128 permutations for decryption. The outputs 215-a, 215-b, and 215-c may represent examples of output portions of the decrypted data (e.g., element-by-element). In some examples, during the cipher stage 230, the memory device may re-encrypt the data to generate a re-encrypted copy of the data that may be stored back to the memory device.

During a finalization stage 235, the memory device may perform a final phase 205-f associated with verification of the data. For example, the final phase 205-f may be associated with decrypting and processing the tag stored with the chunk of data. The tag may be compared with a result of the decryption operation on the rest of the chunk of data. If the stored tag matches the result, the memory device may verify that the data was signed by a host system that has the trusted root key (e.g., an authenticated and verified host system), and the data may be verified via the final output 215-d. If the stored tag does not match, the memory system may not verify the data, and the data may be deleted or the operation may end. Once the data is decrypted and verified, the memory device may use the data for access operations or PIM operations.

As described herein, the security architecture 200 may be integrated with PIM architecture within the memory device to support streamlined PIM operations while decrypting the data on the fly. For example, the host system may active, via an access command, a row or other portion of data for use with PIM. The memory device may read the requested section of encrypted data from the memory cells into a page buffer of the memory device. The memory device may generate the nonce value and may input the session key and nonce value as the inputs 210-a into the security architecture 200 to decrypt the page buffer. The outputs 215 from the security architecture 200 may be provided to one or more processing cores or other PIM components within the memory device. The PIM components may perform multiply-accumulate (MAC) operations using the outputs 215. For example, the outputs 215 may represent decrypted matrix data for the PIM. The PIM components may perform MAC operations or other computations by sequentially multiplying each output 215 (e.g., each entry of a decrypted matrix) with a respective entry of an input vector provided to the memory device for the operation (e.g., via an interface) and accumulating the results. The PIM component(s) may thereby perform the computations sequentially as the security architecture 200 is decrypting the data, which may reduce latency associated with the on-the-fly decryption.

After the full portion of data is decrypted (e.g., at the end of the cipher stage 230), the PIM operations may also be complete. For example, for a row of data, a complete MAC operation may be performed and the full row of data may be decrypted. The memory device may then perform the finalization stage 235 to verify the data and the corresponding MAC operation result. If the data is not verified (e.g., the tag calculated by the security architecture 200 does not match the stored tag), the memory device may dispose of the MAC result as inauthentic. However, if the data is verified (e.g., the calculated tag matches the stored tag), the memory device may store the completed MAC result and continue with PIM operations accordingly. The memory device may, in some examples, set a pass/fail bit that indicates whether the PIM operation can complete or not (e.g., whether a load X (LDX) operation in which the MAC result is loaded or otherwise stored can be complete).

The memory device may thereby perform data decryption on-the-fly at an access granularity. Various examples of different encryption and tag storage granularities, as well as techniques for the memory system to perform its own encryption of the data, are described in further detail elsewhere herein, including with reference to FIG. 3. Enabling a memory system to decrypt data at the time of an associated operation (e.g., rather than at the time of reception), may decrease overhead associated with security of the associated memory system while avoiding a decrease in performance of the memory system. For example, decrypting data on-the-fly decrease write latency at the memory system while maintaining security of the data and avoiding data loss. Additionally, or alternatively, enabling the memory system to adjust a granularity at which the memory system may decrypt data (e.g., and perform other operations with the data) may allow for dynamic adjustment of a balance between data throughput of the memory system and associated costs.

FIG. 3 shows an example of a process flow 300 that supports security architecture for on-the-fly decryption within a memory system in accordance with examples as disclosed herein. The operations of the process flow 300 may be performed by a memory system or one or more controllers associated with a memory system as described herein. For example, the operations of process flow 300 may be performed by a host system 105-b and a memory system 110-b or a controller thereof, which may be examples of a host system 105 and a memory system 110 as described with reference to FIG. 1. The process flow 300 may also include reference to memory devices, and a local controller, which may be examples of the memory devices 145, a memory controller 140, and the local controllers 150, respectively, as described with reference to FIG. 1.

In the following description of the process flow 300, the operations may be performed in a different order than the order shown, or other operations may be added or removed from the process flow 300. For example, some operations may be left out of the process flow 300, may be performed in different orders or at different times, or other operations may be added to the process flow 300. Although a memory system is described as performing the process flow 300, some aspects of some operations may also be performed by one or more other memory systems, memory devices, host devices, controllers, or other electronic devices (e.g., as described herein with respect to FIGS. 1 and 2).

At 305, the host system 105-b may transmit, and the memory system 110-b may receive, a root key. For example, the host system 105-b may transmit a root key associated with the data encryption scheme to the memory system 110-b. As described with reference to FIGS. 1 and 2, the host system 105-b and the memory system 110-b may exchange a root key during manufacture or in a secure environment before deployment of the systems (e.g., send one time within a secure factory environment). The root key may be stored by both systems in one or more fuses or other non-volatile memory. Each time the memory system 110-b reboots or otherwise resets, the memory system 110-b and the host system 105-b may both use the root key as a seed to a KDF for generating one or more ephemeral keys, which may be referred to as session keys. Additionally, or alternatively, the memory system 110-b may include one or more mode registers configured to enable a re-derivation of the session key(s). For example, the host system 105-b, the memory system 110-b, or both may reset the mode register value to request that a new session key be derived, and both systems will re-derive the keys accordingly. The memory system 110-b and the host system 105-b may use the session key(s) for decrypting data during the associated session.

During a system initialization or other re-keying event, the host system 105-b may generate a KDF nonce value and an initialization nonce value, which may be generated using one or more random number generation techniques. The host system 105-b may encrypt the KDF nonce value using the root key and the initialization nonce value. The host system 105-b may send the encrypted KDF nonce value to the memory system 110-b with the initialization nonce in a non-encrypted (cleartext) form. The memory system 110-b may decrypt and authenticate the KDF nonce using the root key and the received initialization nonce. The host system 105-b and the memory system 110-b may thereby be able to equivalently combine the root key and the authenticated KDF none to create a session key. To generate a unique row nonce, as described with reference to FIG. 2, the memory system 110-b and the host system 105-b may combine the roto key, the KDF nonce, and the row address.

At 310, the host system 105-b may transmit, and the memory system 110-b may receive, data. For example, the memory system 110-b may receive the data in encrypted form from the host system 105-b via a system bus. The data may be encrypted according to a data encryption scheme associated with the root key (e.g., using the session key as described herein), and may be designated for storage at the memory system 110-b. In some examples, the data may be an example of a model for use in PIM operations at the memory system.

In some examples, the data may be encrypted according to one or more model flags. Each model flag may include metadata (e.g., a nonce value, other information) associated with a portion of data, which may be used to generate various tags and values for decryption of each portion of the data. In some cases, the memory system 110-b may receive the model flags from the host system 105-b along with the data, and may store the model flags with the data.

At 315, the host system 105-b may transmit, and the memory system 110-b may receive, one or more tags. For example, the host system 105-b may transmit one or more tags with the data to the memory system 110-b via the system bus. In some examples, the one or more tags may include unique values or sequences for cryptographic verification of the data, and may be associated with the data encryption scheme, one or more keys, the data, or any combination thereof.

At 320, the memory system 110-b may store the data. For example, in response to receiving the data, the memory system 110-b (e.g., a controller thereof) may store the data in encrypted form in memory (e.g., memory cells, memory arrays, volatile memory) of the memory system 110-b. At 325, in some examples, the memory system 110-b may store the one or more tags. For example, in response to receiving the one or more tags, the memory system may store the one or more tags with the data in memory (e.g., memory cells, memory arrays, volatile memory) of the memory system 110-b. If the host system 105-b encrypts the data on a per-row basis, the memory system 110-b may store each row of data with a respective tag in the memory array. Additionally, or alternatively, the tags may be stored per some other encryption granularity, such as one tag per PIM model, one tag per column, one tag per row, or the like.

At 330, in some examples described herein, the memory system 110-b may decrypt and locally re-encrypt the stored data. For example, after storing the data, the memory system 110-b may receive a re-encryption indication (e.g., via a flag, command, mode register) from the host system 105-b (e.g., not illustrated). Additionally, or alternatively, the re-encryption indication may be set during initialization of the memory system 110-b (e.g., during manufacturing). In response to receiving the indication, the data, or both, the memory system 110-b may decrypt the stored data from the encrypted form to a decrypted form according to the data encryption scheme and one or more keys associated with the root key. The memory system 110-b may perform the decryption according to the decryption scheme described with reference to FIG. 2. For example, the memory system 110-b may generate (e.g., calculate) one or more tags while decrypting and may compare the tags with the tags received from the host system 105-b and stored at the memory system 110-b. If the data is encrypted on a model-level, the memory system 110-b may generate a single tag associated with verifying the entirety of the decrypted data. In other examples, the memory system 110-b may generate multiple tags associated with data. Each of the multiple tags may be associated with verifying a portion of the data associated with (e.g., stored to) a row of memory cells. After decrypting the data and generating the one or more tags, the memory system 110-b may verify the data by comparing the one or more generated tags to the one or more tags previously stored to the memory system 110-b (e.g., received from the host system 105-b). In the case that the tags do not match (e.g., are not the same), the data may compromised (e.g., unverifiable, bad, from an unauthorized host system) and the memory system 110-b may discard the data or otherwise refrain from further use of the data until it is verified. In the case that the tags do match (e.g., are the same), the data may be verified (e.g., verifiable, from an authorized host system) and the memory system 110-b may continue with re-encryption of the data.

After decrypting the data, and in response to verifying the data, the memory system 110-b may re-encrypt the data using one or more local keys. For example, the memory system 110-b may re-encrypt the data using one or more keys that are not necessarily associated with (e.g., known to) the host system 105-b. In some examples, the one or more keys may be associated with all of the data, while in other examples the one or more keys are each associated with a portion of the data (e.g., are each associated with a portion of data stored to a row of memory cells, are each associated with one or more row addresses including the data). In response to re-encrypting the data, the memory system 110-b may store the data in a re-encrypted form (e.g., encrypted according to a different encryption scheme than the original encrypted form) in rows of memory cells of the memory (e.g., memory cells, memory arrays, volatile memory) of the memory system 110-b, which may include re-writing the data or otherwise writing over the previously-stored data. The memory system 110-b may decrypt and re-encrypt the data sequentially by row of memory cell, as further described herein with reference to FIG. 2. The memory system 110-b may decrypt and re-encrypt the data according to a pre-charge command received from the host system 105-b. Additionally, or alternatively, the memory system 110-b may perform the re-encryption of the data during an initial write operation of the data if the data is sequentially written to the memory devices of the memory system 110-b (e.g., before storing the data to the memory system). The host system 105-b may enable the memory system 110-b to perform such proactive decryption and re-encryption if, for example, the host system 105-b does not know the physical row storage locations within the memory system 110-b, and the host system 105-b is not able to leverage this information to generate a nonce based on the row addresses. In such cases, generation, by the host system 105-b, of per-row tags may not be supported, and the decryption and re-encryption by the memory system 110-b may provide for the memory system 110-b to have granular verification information (e.g., tags).

If the memory system 110-b performs the verification of the data at this stage, the memory system 110-b may not perform another verification at subsequent decryption stages. That is, the verification may be performed at one time (e.g., within one duration) after the data is received. In such cases, the decryption described with reference to FIG. 2 may exclude the ultimate verification of the data using the tags. For example, the memory system may not store additional tags with the re-encrypted data, and therefore may not compare any tag calculations during subsequent decryption phases. Such techniques may reduce latency and processing as compared with verifying the data each time it is accessed.

At 335, the host system 105-b may transmit, and the memory system 110-b may receive, a command. The command may indicate an operation for the memory system 110-b to perform on (e.g., with, using) the stored data. In some examples, the operation may be an example of a PIM operation associated with the PIM model (e.g., the data), or some other access operation.

At 340, the memory system 110-b may retrieve the stored data. For example, in response to receiving the command, the memory system 110-b may retrieve at least a portion of the stored data to prepare for performance of the operation indicated by the command. To retrieve the data, the memory system 110-b may transfer the data in encrypted form from one or more memory cells of the memory system 110-b to a page buffer of the memory system 110-b.

At 345, the memory system 110-b may decrypt the data. In response to retrieving the data, the memory system 110-b may decrypt one or more portions of the stored data. The memory system 110-b may decrypt the data using one or more keys (e.g., the generated session key) associated with the root key if the data is encrypted in its original form. If the data was re-encrypted locally at 330, the memory system may use one or more second keys for decryption, where the second keys may be local keys that may or may not be based on the root key. In the case that the memory system 110-b generated a row-specific nonce value, the memory system 110-b may use the row-specific nonce value and the session key to decrypt the data.

At 350, as part of decrypting the data, the memory system 110-b may generate one or more other tags. For example, as described with reference to FIG. 2, the decryption process may produce one or more calculated tags. The memory system 110-b may generate a single tag associated with verifying the one or more portions of the decrypted data or the entirely of the data. In other examples, the memory system 110-b may generate tags using the session key and an address of the row of memory cells at which the data is stored, depending on a granularity at which the data is decrypted, as described with reference to FIG. 2. Each of the tags may be associated with verifying a portion of the data associated with (e.g., stored to) a row of memory cells.

At 355, the memory system 110-b may verify the data. For example, after decrypting the data and generating the one or more tags, the memory system 110-b may verify the data (e.g., the portion of the data) by comparing the one or more generated tags to the one or more tags previously stored to the memory system 110-b (e.g., received from the host system 105-b). In the case that the tags do not match (e.g., are not the same), the data may not be signed by the host system 105-b (e.g., unverifiable, bad, from an unauthorized host system) and the memory system 110-b may set a “fail” indication which may not allow for further operations associated with the data. In the case that the tags do match (e.g., are the same), the data may be verified (e.g., verifiable, from an authorized host system) and the memory system 110-b may set a “pass” indication which may allow for further operations associated with the verified data. In determining the data to be verified, the memory system 110-b may determine that the data was signed by the host system 105-b (e.g., prior to the communication of the data at 305) using one or more keys associated with the root key. In some examples, the memory system 110-b may perform the verification operation prior to storing the data to the memory system 110-b. The memory system 110-b may perform the verification to determine whether to perform the operation associated with the command.

At 360, in some examples, the memory system 110-b may perform the operation. For example, in response to the memory system 110-b determining the data to be signed by the host system 105-b (e.g., verify the data), the memory system 110-b may perform the operation associated with the received command using the data (e.g., the portion of the data).

At 365, in some other examples, the memory system 110-b may refrain from performing the operation. For example, in response to the memory system 110-b determining the data to not be signed by the host system 105-b (e.g., failing to verify the data), the memory system 110-b may refrain from performing the operation associated with the received command.

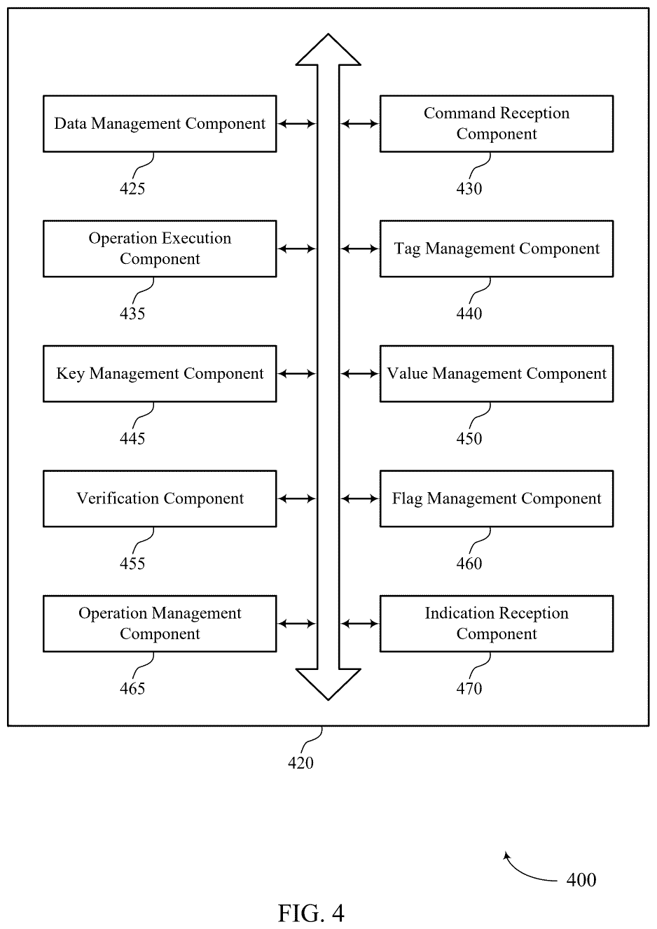

FIG. 4 shows a block diagram 400 of a memory system 420 that supports security architecture for on-the-fly decryption within a memory system in accordance with examples as disclosed herein. The memory system 420 may be an example of aspects of a memory system as described with reference to FIGS. 1 through 3. The memory system 420, or various components thereof, may be an example of means for performing (e.g., to cause the memory system 420 to perform) various aspects of security architecture for on-the-fly decryption within a memory system as described herein. For example, the memory system 420 may include a data management component 425, a command reception component 430, an operation execution component 435, a tag management component 440, a key management component 445, a value management component 450, a verification component 455, a flag management component 460, an operation management component 465, an indication reception component 470, or any combination thereof. Each of these components, or components of subcomponents thereof (e.g., one or more processors, one or more memories), may communicate, directly or indirectly, with one another (e.g., via one or more buses).

The data management component 425 may be configured as or otherwise support a means for receiving data for storage by the memory system, where the data is received via a system bus in an encrypted form in accordance with a data encryption scheme associated with a root key. In some examples, the data management component 425 may be configured as or otherwise support a means for storing, to a plurality of memory cells within the memory system, the data in the encrypted form. In some examples, the data management component 425 may be configured as or otherwise support a means for retrieving, in accordance with an operation of the memory system, a portion of the data in the encrypted form from one or more memory cells of the plurality of memory cells. In some examples, the data management component 425 may be configured as or otherwise support a means for decrypting, before performing the operation using the portion of the data, the portion of the data in accordance with one or more keys that are associated with the root key.

In some examples, the tag management component 440 may be configured as or otherwise support a means for receiving, via the system bus and with the data, one or more first tags for cryptographic verification of the data, the one or more first tags in accordance with the data, the data encryption scheme and the one or more keys. In some examples, the tag management component 440 may be configured as or otherwise support a means for storing the one or more first tags with the data to the plurality of memory cells within the memory system.

In some examples, the tag management component 440 may be configured as or otherwise support a means for generating, in accordance with decrypting the portion of the data, a second tag in accordance with the portion of the data and the data encryption scheme. In some examples, the verification component 455 may be configured as or otherwise support a means for verifying, in accordance with a comparison between the second tag and a first tag of the one or more first tags, the portion of the data, where verifying the portion of the data confirms the portion of the data was signed by a host system in accordance with one or more second keys associated with the root key.

In some examples, the tag management component 440 may be configured as or otherwise support a means for generating, in accordance with decrypting the portion of the data, one or more second tags each associated with a respective row of memory cells, of a plurality of rows of memory cells to which the portion of the data is stored, where each second tag of the one or more second tags is in accordance with a session key and an address of the respective row of memory cells. In some examples, the verification component 455 may be configured as or otherwise support a means for verifying, in accordance with one or more comparisons between the one or more second tags and the one or more first tags, the portion of the data, where verifying the portion of the data confirms the portion of the data was signed by a host system in accordance with one or more second keys associated with the root key, and where each first tag of the one or more first tags is associated with verification of a respective row of memory cells of the plurality of rows of memory cells. In some examples, the operation management component 465 may be configured as or otherwise support a means for determining whether to execute the operation using the portion of the data in accordance with verifying the portion of the data.

In some examples, the tag management component 440 may be configured as or otherwise support a means for generating, in accordance with decrypting the data, a third tag in accordance with a session key, the third tag associated with all of the data received in the encrypted form. In some examples, the verification component 455 may be configured as or otherwise support a means for verifying, in accordance with a comparison between the third tag and the one or more first tags, the data, where verifying the data confirms that the data was signed by a host system, and where storing, the portion of the data to the memory cells is in accordance with verifying the host system.

In some examples, the indication reception component 470 may be configured as or otherwise support a means for receiving, via the system bus after storing the data in the encrypted form, a re-encryption indication. In some examples, the data management component 425 may be configured as or otherwise support a means for decrypting, in accordance with the re-encryption indication, the data in accordance with the data encryption scheme and the one or more keys that are in accordance with the root key. In some examples, the data management component 425 may be configured as or otherwise support a means for re-encrypting, in accordance with the re-encryption indication, the data using the data encryption scheme and one or more second keys. In some examples, the data management component 425 may be configured as or otherwise support a means for storing, to the plurality of memory cells, the data in the encrypted form in accordance with re-encrypting the data.

In some examples, the tag management component 440 may be configured as or otherwise support a means for generating, in accordance with decrypting the data in accordance with the re-encryption indication, a second tag. In some examples, the verification component 455 may be configured as or otherwise support a means for verifying, in accordance with a comparison between the second tag and the one or more first tags, the data, where re-encrypting the data is in accordance with verifying the data.

In some examples, the tag management component 440 may be configured as or otherwise support a means for generating, in accordance with re-encrypting the data, a plurality of row verification tags, where each row verification tag of the plurality of row verification tags is stored with a respective portion of the data in a respective row of memory cells and is in accordance with a row address of the respective row of memory cells, and where the one or more keys for decrypting the portion of the data are further in accordance with one or more row addresses of one or more rows that include the portion of the data.

In some examples, the tag management component 440 may be configured as or otherwise support a means for receiving, prior to an initialization operation of the memory system, the root key. In some examples, the key management component 445 may be configured as or otherwise support a means for storing the root key within the memory system. In some examples, the key management component 445 may be configured as or otherwise support a means for generating, after the initialization operation, a session key in accordance with a key derivation function and using the root key and a random number as key derivation function seeds, where the one or more keys for decrypting the portion of the data are in accordance with the session key.

In some examples, the value management component 450 may be configured as or otherwise support a means for receiving a first nonce value and a second nonce value, the second nonce value including an encrypted nonce value. In some examples, the value management component 450 may be configured as or otherwise support a means for decrypting the second nonce value in accordance with the first nonce value and the root key. In some examples, the key management component 445 may be configured as or otherwise support a means for generating a session key in accordance with the second nonce value and the root key, where the one or more keys for decrypting the portion of the data are in accordance with the session key.

In some examples, the verification component 455 may be configured as or otherwise support a means for performing, in accordance with decrypting the portion of the data, a verification operation of a host system associated with the data. In some examples, the operation execution component 435 may be configured as or otherwise support a means for executing, in accordance with verifying the host system and after decrypting the portion of the data, the operation using the portion of the data.

In some examples, the data management component 425 may be configured as or otherwise support a means for performing, in accordance with decrypting the portion of the data, a verification operation of a host system associated with the data. In some examples, the operation execution component 435 may be configured as or otherwise support a means for refraining from executing the operation using the portion of the data in accordance with failing to verify the host system during the verification operation.

In some examples, the data includes a model for PIM operations by the memory system; and the operation includes a PIM operation.

The command reception component 430 may be configured as or otherwise support a means for receiving a command for execution of an operation using data stored by one or more memory cells within the memory system. In some examples, the data management component 425 may be configured as or otherwise support a means for transferring, in response to the command, the data and a first tag from the one or more memory cells to a page buffer of the memory system, where the data includes encrypted data. In some examples, the data management component 425 may be configured as or otherwise support a means for decrypting the data in accordance with a nonce and a session key associated with the memory system. The operation execution component 435 may be configured as or otherwise support a means for determining whether to complete the operation in accordance with a comparison between a second tag generated by the memory system and the first tag.

In some examples, the flag management component 460 may be configured as or otherwise support a means for setting, in accordance with the comparison between the second tag and the first tag, a flag that indicates whether the data is verified or not, where determining whether to complete the operation is in accordance with a value of the flag.

In some examples, the data is stored to a plurality of rows of memory cells, each row of memory cells including a respective portion of the data and a respective row tag for verification of the respective portion of the data in the row, decrypting the data includes decrypting each row of the plurality of rows in accordance with a respective nonce associated with each row and the session key, and the respective nonce is in accordance with a row address of each row of the plurality of rows.

In some examples, the tag management component 440 may be configured as or otherwise support a means for generating the second tag in accordance with decrypting the data. In some examples, the data management component 425 may be configured as or otherwise support a means for comparing the second tag with the first tag. In some examples, the data management component 425 may be configured as or otherwise support a means for authenticating the data in accordance with the comparison, where authenticating the data confirms that the data was signed by a host system in accordance with one or more keys associated with the session key.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 420 to perform one or more operations. In some examples, the described functionality of the memory system 420, or various components thereof, may be implemented at least in part by instructions (e.g., stored in memory, non-transitory computer-readable medium) executable by such at least one processor to cause the memory system 420 to perform one or more operations.

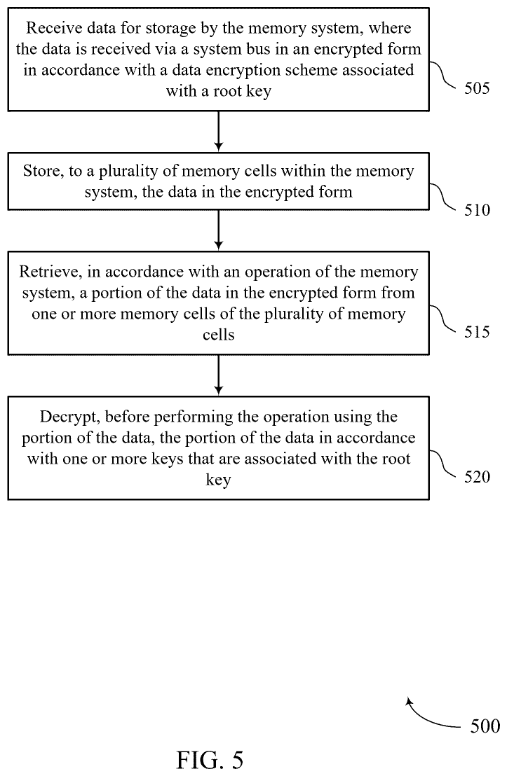

FIG. 5 shows a flowchart illustrating a method 500 that supports security architecture for on-the-fly decryption within a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving data for storage by the memory system, where the data is received via a system bus in an encrypted form in accordance with a data encryption scheme associated with a root key. In some examples, aspects of the operations of 505 may be performed by a data management component 425.

At 510, the method may include storing, to a plurality of memory cells within the memory system, the data in the encrypted form. In some examples, aspects of the operations of 510 may be performed by a data management component 425.

At 515, the method may include retrieving, in accordance with an operation of the memory system, a portion of the data in the encrypted form from one or more memory cells of the plurality of memory cells. In some examples, aspects of the operations of 515 may be performed by a data management component 425.

At 520, the method may include decrypting, before performing the operation using the portion of the data, the portion of the data in accordance with one or more keys that are associated with the root key. In some examples, aspects of the operations of 520 may be performed by a data management component 425.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving data for storage by the memory system, where the data is received via a system bus in an encrypted form in accordance with a data encryption scheme associated with a root key; storing, to a plurality of memory cells within the memory system, the data in the encrypted form; retrieving, in accordance with an operation of the memory system, a portion of the data in the encrypted form from one or more memory cells of the plurality of memory cells; and decrypting, before performing the operation using the portion of the data, the portion of the data in accordance with one or more keys that are associated with the root key.

Aspect 2: The method, apparatus, or non-transitory computer-readable medium of aspect 1, further including operations, features, circuitry, logic, means, or instructions, or any combination thereof for receiving, via the system bus and with the data, one or more first tags for cryptographic verification of the data, the one or more first tags in accordance with the data, the data encryption scheme and the one or more keys and storing the one or more first tags with the data to the plurality of memory cells within the memory system.

Aspect 3: The method, apparatus, or non-transitory computer-readable medium of aspect 2, further including operations, features, circuitry, logic, means, or instructions, or any combination thereof for generating, in accordance with decrypting the portion of the data, a second tag in accordance with the portion of the data and the data encryption scheme and verifying, in accordance with a comparison between the second tag and a first tag of the one or more first tags, the portion of the data, where verifying the portion of the data confirms the portion of the data was signed by a host system in accordance with one or more second keys associated with the root key.

Aspect 4: The method, apparatus, or non-transitory computer-readable medium of any of aspects 2 through 3, further including operations, features, circuitry, logic, means, or instructions, or any combination thereof for generating, in accordance with decrypting the portion of the data, one or more second tags each associated with a respective row of memory cells, of a plurality of rows of memory cells to which the portion of the data is stored, where each second tag of the one or more second tags is in accordance with a session key and an address of the respective row of memory cells; verifying, in accordance with one or more comparisons between the one or more second tags and the one or more first tags, the portion of the data, where verifying the portion of the data confirms the portion of the data was signed by a host system in accordance with one or more second keys associated with the root key, and where each first tag of the one or more first tags is associated with verification of a respective row of memory cells of the plurality of rows of memory cells; and determining whether to execute the operation using the portion of the data in accordance with verifying the portion of the data.

Aspect 5: The method, apparatus, or non-transitory computer-readable medium of any of aspects 2 through 4, further including operations, features, circuitry, logic, means, or instructions, or any combination thereof for generating, in accordance with decrypting the data, a third tag in accordance with a session key, the third tag associated with all of the data received in the encrypted form and verifying, in accordance with a comparison between the third tag and the one or more first tags, the data, where verifying the data confirms that the data was signed by a host system, and where storing, the portion of the data to the memory cells is in accordance with verifying the host system.

Aspect 6: The method, apparatus, or non-transitory computer-readable medium of any of aspects 2 through 5, further including operations, features, circuitry, logic, means, or instructions, or any combination thereof for receiving, via the system bus after storing the data in the encrypted form, a re-encryption indication; decrypting, in accordance with the re-encryption indication, the data in accordance with the data encryption scheme and the one or more keys that are in accordance with the root key; re-encrypting, in accordance with the re-encryption indication, the data using the data encryption scheme and one or more second keys; and storing, to the plurality of memory cells, the data in the encrypted form in accordance with re-encrypting the data.

Aspect 7: The method, apparatus, or non-transitory computer-readable medium of aspect 6, further including operations, features, circuitry, logic, means, or instructions, or any combination thereof for generating, in accordance with decrypting the data in accordance with the re-encryption indication, a second tag and verifying, in accordance with a comparison between the second tag and the one or more first tags, the data, where re-encrypting the data is in accordance with verifying the data.

Aspect 8: The method, apparatus, or non-transitory computer-readable medium of any of aspects 6 through 7, further including operations, features, circuitry, logic, means, or instructions, or any combination thereof for generating, in accordance with re-encrypting the data, a plurality of row verification tags, where each row verification tag of the plurality of row verification tags is stored with a respective portion of the data in a respective row of memory cells and is in accordance with a row address of the respective row of memory cells, and where the one or more keys for decrypting the portion of the data are further in accordance with one or more row addresses of one or more rows that include the portion of the data.

Aspect 9: The method, apparatus, or non-transitory computer-readable medium of any of aspects 1 through 8, further including operations, features, circuitry, logic, means, or instructions, or any combination thereof for receiving, prior to an initialization operation of the memory system, the root key; storing the root key within the memory system; and generating, after the initialization operation, a session key in accordance with a key derivation function and using the root key and a random number as key derivation function seeds, where the one or more keys for decrypting the portion of the data are in accordance with the session key.

Aspect 10: The method, apparatus, or non-transitory computer-readable medium of any of aspects 1 through 9, further including operations, features, circuitry, logic, means, or instructions, or any combination thereof for receiving a first nonce value and a second nonce value, the second nonce value including an encrypted nonce value; decrypting the second nonce value in accordance with the first nonce value and the root key; and generating a session key in accordance with the second nonce value and the root key, where the one or more keys for decrypting the portion of the data are in accordance with the session key.

Aspect 11: The method, apparatus, or non-transitory computer-readable medium of any of aspects 1 through 10, further including operations, features, circuitry, logic, means, or instructions, or any combination thereof for performing, in accordance with decrypting the portion of the data, a verification operation of a host system associated with the data and executing, in accordance with verifying the host system and after decrypting the portion of the data, the operation using the portion of the data.

Aspect 12: The method, apparatus, or non-transitory computer-readable medium of any of aspects 1 through 11, further including operations, features, circuitry, logic, means, or instructions, or any combination thereof for performing, in accordance with decrypting the portion of the data, a verification operation of a host system associated with the data and refraining from executing the operation using the portion of the data in accordance with failing to verify the host system during the verification operation.

Aspect 13: The method, apparatus, or non-transitory computer-readable medium of any of aspects 1 through 12, where the data includes a model for processor-in-memory operations by the memory system; and the operation includes a processor-in-memory operation.

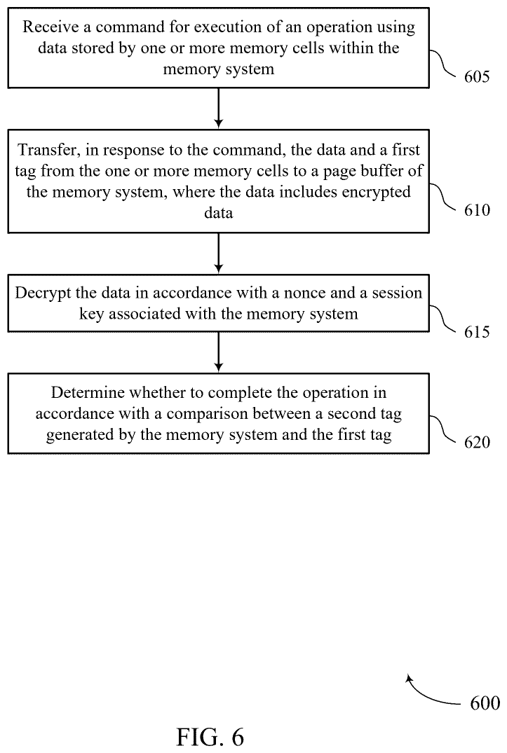

FIG. 6 shows a flowchart illustrating a method 600 that supports security architecture for on-the-fly decryption within a memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a command for execution of an operation using data stored by one or more memory cells within the memory system. In some examples, aspects of the operations of 605 may be performed by a command reception component 430.

At 610, the method may include transferring, in response to the command, the data and a first tag from the one or more memory cells to a page buffer of the memory system, where the data includes encrypted data. In some examples, aspects of the operations of 610 may be performed by a data management component 425.

At 615, the method may include decrypting the data in accordance with a nonce and a session key associated with the memory system. In some examples, aspects of the operations of 615 may be performed by a data management component 425.

At 620, the method may include determining whether to complete the operation in accordance with a comparison between a second tag generated by the memory system and the first tag. In some examples, aspects of the operations of 620 may be performed by an operation execution component 435.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for receiving a command for execution of an operation using data stored by one or more memory cells within the memory system; transferring, in response to the command, the data and a first tag from the one or more memory cells to a page buffer of the memory system, where the data includes encrypted data; decrypting the data in accordance with a nonce and a session key associated with the memory system; and determining whether to complete the operation in accordance with a comparison between a second tag generated by the memory system and the first tag.

Aspect 15: The method, apparatus, or non-transitory computer-readable medium of aspect 14, further including operations, features, circuitry, logic, means, or instructions, or any combination thereof for setting, in accordance with the comparison between the second tag and the first tag, a flag that indicates whether the data is verified or not, where determining whether to complete the operation is in accordance with a value of the flag.

Aspect 16: The method, apparatus, or non-transitory computer-readable medium of any of aspects 14 through 15, where the data is stored to a plurality of rows of memory cells, each row of memory cells including a respective portion of the data and a respective row tag for verification of the respective portion of the data in the row, decrypting the data includes decrypting each row of the plurality of rows in accordance with a respective nonce associated with each row and the session key, and the respective nonce is in accordance with a row address of each row of the plurality of rows.

Aspect 17: The method, apparatus, or non-transitory computer-readable medium of any of aspects 14 through 16, further including operations, features, circuitry, logic, means, or instructions, or any combination thereof for generating the second tag in accordance with decrypting the data; comparing the second tag with the first tag; and authenticating the data in accordance with the comparison, where authenticating the data confirms that the data was signed by a host system in accordance with one or more keys associated with the session key.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive data for storage by the memory system, wherein the data is received via a system bus in an encrypted form in accordance with a data encryption scheme associated with a root key;
store, to a plurality of memory cells within the memory system, the data in the encrypted form;
retrieve, in accordance with an operation of the memory system, a portion of the data in the encrypted form from one or more memory cells of the plurality of memory cells; and
decrypt, before performing the operation using the portion of the data, the portion of the data in accordance with one or more keys that are associated with the root key.

2. The memory system of claim 1, wherein the processing circuitry is further configured to cause the memory system to:
receive, via the system bus and with the data, one or more first tags for cryptographic verification of the data, the one or more first tags in accordance with the data, the data encryption scheme and the one or more keys; and
store the one or more first tags with the data to the plurality of memory cells within the memory system.

3. The memory system of claim 2, wherein the processing circuitry is further configured to cause the memory system to:
generate, in accordance with decrypting the portion of the data, a second tag in accordance with the portion of the data and the data encryption scheme; and
verify, in accordance with a comparison between the second tag and a first tag of the one or more first tags, the portion of the data, wherein verification of the portion of the data confirms the portion of the data was signed by a host system in accordance with one or more second keys associated with the root key.

4. The memory system of claim 2, wherein the processing circuitry is further configured to cause the memory system to:
generate, in accordance with decrypting the portion of the data, one or more second tags each associated with a respective row of memory cells, of a plurality of rows of memory cells to which the portion of the data is stored, wherein each second tag of the one or more second tags is in accordance with a session key and an address of the respective row of memory cells;
verify, in accordance with one or more comparisons between the one or more second tags and the one or more first tags, the portion of the data, wherein verification of the portion of the data confirms the portion of the data was signed by a host system in accordance with one or more second keys associated with the root key, and wherein each first tag of the one or more first tags is associated with verification of a respective row of memory cells of the plurality of rows of memory cells; and
determine whether to execute the operation using the portion of the data in accordance with verifying the portion of the data.

5. The memory system of claim 2, wherein the processing circuitry is further configured to cause the memory system to:
generate, in accordance with decrypting the data, a third tag in accordance with a session key, the third tag associated with all of the data received in the encrypted form; and
verify, in accordance with a comparison between the third tag and the one or more first tags, the data, wherein verification of the data confirms that the data was signed by a host system, and wherein storing the portion of the data to the one or more memory cells is in accordance with verifying the host system.

6. The memory system of claim 2, wherein the processing circuitry is further configured to cause the memory system to:
receive, via the system bus after storing the data in the encrypted form, a re-encryption indication;
decrypt, in accordance with the re-encryption indication, the data in accordance with the data encryption scheme and the one or more keys that are in accordance with the root key;
re-encrypt, in accordance with the re-encryption indication, the data using the data encryption scheme and one or more second keys; and
store, to the plurality of memory cells, the data in the encrypted form in accordance with re-encrypting the data.

7. The memory system of claim 6, wherein the processing circuitry is further configured to cause the memory system to:
generate, in accordance with decrypting the data in accordance with the re-encryption indication, a second tag; and
verify, in accordance with a comparison between the second tag and the one or more first tags, the data, wherein re-encryption of the data is in accordance with verification of the data.

8. The memory system of claim 6, wherein the processing circuitry is further configured to cause the memory system to:
generate, in accordance with re-encrypting the data, a plurality of row verification tags, wherein each row verification tag of the plurality of row verification tags is stored with a respective portion of the data in a respective row of memory cells and is in accordance with a row address of the respective row of memory cells, and wherein the one or more keys for decrypting the portion of the data are further in accordance with one or more row addresses of one or more rows that include the portion of the data.

9. The memory system of claim 1, wherein the processing circuitry is further configured to cause the memory system to:
receive, prior to an initialization operation of the memory system, the root key;
store the root key within the memory system; and
generate, after the initialization operation, a session key in accordance with a key derivation function and using the root key and a random number as key derivation function seeds, wherein the one or more keys for decrypting the portion of the data are in accordance with the session key.

10. The memory system of claim 1, wherein the processing circuitry is further configured to cause the memory system to:
receive a first nonce value and a second nonce value, the second nonce value comprising an encrypted nonce value;
decrypt the second nonce value in accordance with the first nonce value and the root key; and
generate a session key in accordance with the second nonce value and the root key, wherein the one or more keys for decrypting the portion of the data are in accordance with the session key.

11. The memory system of claim 1, wherein the processing circuitry is further configured to cause the memory system to:
perform, in accordance with decrypting the portion of the data, a verification operation of a host system associated with the data; and
execute, in accordance with verifying the host system and after decrypting the portion of the data, the operation using the portion of the data.

12. The memory system of claim 1, wherein the processing circuitry is further configured to cause the memory system to:
perform, in accordance with decrypting the portion of the data, a verification operation of a host system associated with the data; and
refrain from executing the operation using the portion of the data in accordance with failing to verify the host system during the verification operation.

13. The memory system of claim 1, wherein:
the data comprises a model for processor-in-memory operations by the memory system; and
the operation comprises a processor-in-memory operation.

14. A memory system, comprising:
one or more memory devices; and
processing circuitry coupled with the one or more memory devices and configured to cause the memory system to:
receive a command for execution of an operation using data stored by one or more memory cells within the memory system;
transfer, in response to the command, the data and a first tag from the one or more memory cells to a page buffer of the memory system, wherein the data comprises encrypted data;
decrypt the data in accordance with a nonce and a session key associated with the memory system; and
determine whether to complete the operation in accordance with a comparison between a second tag generated by the memory system and the first tag.

15. The memory system of claim 14, wherein the processing circuitry is further configured to cause the memory system to:
set, in accordance with the comparison between the second tag and the first tag, a flag that indicates whether the data is verified or not, wherein determining whether to complete the operation is in accordance with a value of the flag.

16. The memory system of claim 14, wherein the data is stored to a plurality of rows of memory cells, each row of memory cells comprising a respective portion of the data and a respective row tag for verification of the respective portion of the data in the row, and wherein, to decrypt the data, the processing circuitry is configured to cause the memory system to:
decrypt each row of the plurality of rows in accordance with a respective nonce associated with each row and the session key, wherein the respective nonce is in accordance with a row address of each row of the plurality of rows.

17. The memory system of claim 14, wherein the processing circuitry is further configured to cause the memory system to:
generate the second tag in accordance with decrypting the data;
compare the second tag with the first tag; and
authenticate the data in accordance with the comparison, wherein authenticating the data confirms that the data was signed by a host system in accordance with one or more keys associated with the session key.

18. A method by a memory system, comprising:
receiving data for storage by the memory system, wherein the data is received via a system bus in an encrypted form in accordance with a data encryption scheme associated with a root key;
storing, to a plurality of memory cells within the memory system, the data in the encrypted form;
retrieving, in accordance with an operation of the memory system, a portion of the data in the encrypted form from one or more memory cells of the plurality of memory cells; and
decrypting, before performing the operation using the portion of the data, the portion of the data in accordance with one or more keys that are associated with the root key.

19. The method of claim 18, further comprising:
receiving, via the system bus and with the data, one or more first tags for cryptographic verification of the data, the one or more first tags in accordance with the data, the data encryption scheme and the one or more keys; and
storing the one or more first tags with the data to the plurality of memory cells within the memory system.

20. The method of claim 19, further comprising:
generating, in accordance with decrypting the portion of the data, a second tag in accordance with the portion of the data and the data encryption scheme; and
verifying, in accordance with a comparison between the second tag and a first tag of the one or more first tags, the portion of the data, wherein verifying the portion of the data confirms the portion of the data was signed by a host system in accordance with one or more second keys associated with the root key.

21. The method of claim 19, further comprising:
generating, in accordance with decrypting the portion of the data, one or more second tags each associated with a respective row of memory cells, of a plurality of rows of memory cells to which the portion of the data is stored, wherein each second tag of the one or more second tags is in accordance with a session key and an address of the respective row of memory cells;
verifying, in accordance with one or more comparisons between the one or more second tags and the one or more first tags, the portion of the data, wherein verifying the portion of the data confirms the portion of the data was signed by a host system in accordance with one or more second keys associated with the root key, and wherein each first tag of the one or more first tags is associated with verification of a respective row of memory cells of the plurality of rows of memory cells; and
determining whether to execute the operation using the portion of the data in accordance with verifying the portion of the data.

22. The method of claim 19, further comprising:
generating, in accordance with decrypting the data, a third tag in accordance with a session key, the third tag associated with all of the data received in the encrypted form; and
verifying, in accordance with a comparison between the third tag and the one or more first tags, the data, wherein verifying the data confirms that the data was signed by a host system, and wherein storing, the portion of the data to the one or more memory cells is in accordance with verifying the host system.
